(19) United States
(12) Patent Application Publication
(10) Pub. No.: US 2015/0358225 A1
(43) Pub. Date: Dec. 10, 2015

(54) Method and System For Testing a Broadband Internet Bandwidth

(71) Applicant: Seyed Abdollah Zawari, Pleasanton, CA (US)

(72) Inventor: Seyed Abdollah Zawari, Pleasanton, CA (US)

(21) Appl. No.: 14/298,958

(22) Filed: Jun. 8, 2014

(51) Int. Cl. H04L 12/26; H04L 29/08

(52) U.S. Cl. CPC H04L 43/50; H04L 67/10; H04L 67/06

(57) ABSTRACT

The present invention is directed to on-demand testing of broadband internet bandwidth measurement. The method and system performs broadband internet bandwidth testing to determine upload and download data transfer rates between the service node and requesting node to which the user terminals coupled thereto.

### FIELD OF THE INVENTION

This invention relates generally to the field of telecommunications and in particular to broadband network and application service testing through an Applications Programming Interface (API). More specifically, the invention provides for the testing and diagnosis of broadband applications by a broadband application customer or broadband service provider; and a Graphic User Interface (GUI) can be used to implement the API.

### BACKGROUND OF THE INVENTION

High level languages such as object oriented programming languages allow developers to rapidly build and test code. An Applications Programming Interface (API) is a common component of object oriented programming languages which allows developers to build software for a particular application through a reference program library. The reference program library can be linked to hardware for performing specific tasks or functions. In C and other procedural programming languages, the programming is action oriented. For example, C programs are written as functions. An object oriented programming language such as C++ provides abstraction and provides for the creation of classes. Key components of object oriented programming are inheritance, polymorphism, and abstraction. These features provide code reusability, reduced code complexity, easier interpretation, and better visualization. Object oriented programming provides for data variables, or members, that can be contained in classes. C++ for example, contains a set of foundation classes for providing access to programming methods and functions. Java is another object oriented programming languages that focuses on classes and methods for programming. The classes can be used to instantiate other classes that can in turn employ the functionality and behavior of the inherited class methods and variables.

Developers can build new classes or extend existing classes to add new features or functionality. Many class libraries exist which provides for well-defined, carefully tested, well documented, and portable components. The kind of flexibility afforded by the use of standard class libraries speeds up development and testing. Class libraries can be packaged and provided as a single distribution. Applications Programming Interfaces (API) are library modules for enhancing capabilities or extending functionality. An API can open up resources that may be unavailable to a developer or may require a developer to write underlying device drivers. Device drivers convert information in one format on one hardware into a format that is interpretable on another platform. Device drivers are common software for hardware devices such as cameras, printers, copiers, DVD drives, and multimedia components that interface to a computer system. Device drivers may be proprietary solutions that provide operational utility through an API. The API opens up communication to the device, thereby providing developers access to the underlying resources offered by the device. An API provides a developer a common access point through a programming language to communicate with the underlying platform or to provide access to proprietary features.

A program may have API's that allow developers to tap access to the functionality provided by the program. In other words, a program can convert collected data into various information that is specific to that set of data. For example, a mouse converts physical movement (data) of a mouse to a coordinate (information) that can be understood by the computer.

Similarly, an API can also be used to convert data packets to information regarding the connection and speed of broadband Internet. Broadband—high speed, always-on Internet connectivity—represents the next phase in the evolution of the Internet. In fact, experts predict broadband will enable applications and services that transform our economy, education, health-care, Research and Development, entertainment, homeland security, military effectiveness and quality of life. The continued deployment and usage of broadband and broadband applications and services will therefore significantly impact future broadband customers of all types, be they individual consumers or businesses.

With such extraordinary possibilities, robust broadband demand and usage seems inevitable. Despite this tremendous potential however, there are a number of factors that negatively impact the robustness of the demand. In particular, for consumers and businesses alike, disappointment with the quality and or reliability of service, coupled with frustration caused by difficult provisioning, installation, diagnosis, repair, or service, may seriously limit or delay broadband adoption.

The magnitude and difficulty of the problem is understood by first noting that much of the attractiveness of broadband is derived from the rich array of “on-demand” applications such as: streaming media including Internet radio, peer-to-peer or multiplayer game playing, video-on-demand, and telephony including voice-over-IP (VoIP) and video phone/conferencing. Deploying and delivering these services requires a complex combination of multiple technologies, systems, and commercial organizational entities including access service providers, Internet service providers and broadband application service providers.

Consequently, there is developing in the broadband environment an almost infinite number of combinations of hardware, operating systems, installed applications software, telecommunications facilities, and interconnected and/or related devices. When this is further combined with the varied access services/providers and Internet services/providers and application service providers available, it results in a customer service nightmare in diagnosing problems, let alone solving them. In the broadband-connected home for example, customer service expertise must now include computing equipment, networking equipment, telecommunications equipment, systems software, applications software, consumer electronics, and—down the road—intelligent consumer appliances.

The bandwidth of a data transmission system is determined based upon the speed at which data can be transferred between two points within the system. Thus, for a PC or other computer system connected to the Internet, the downstream bandwidth is the speed, in bits per second, that data can be transferred (or “downloaded”) to the PC from the Internet while the upstream bandwidth is the speed, in bits per second, that data can be transferred (or “uploaded”) from the PC to the Internet. When connected to a selected site on the Internet, a variety of factors can dramatically affect both downstream and upstream bandwidth. For example, a poorly configured PC, a substandard connection with the ISP, an overloaded gateway to the Internet, an overloaded Internet backbone, an excessive hop count to the selected Internet site or an inadequate server at the selected site may all adversely affect bandwidth.

Unfortunately however, different locations in a provider's network have different amounts of available bandwidth for supplying those services to a customer. If a communication link to the customer does not have bandwidth sufficient for a particular service, then the customer cannot use the service most effectively, it at all. Therefore, some services offered by a network provider are not feasible for all customers.

Furthermore, broadband service quality and application service quality is typically viewed from the perspective of the service provider network and, as a result, service diagnosis and test tools take a “network-centric” approach without regard to, or ignorant of, the complex premises configuration(s) that are becoming common. As a result, this network-centric approach falls far short of solving the testing needs of today's broadband network environment(s), and will likely become increasingly deficient in the future.

Generally, a broadband Internet connection speed test service measures the bandwidth (speed) and latency of a visitor's internet connection against one of many geographically dispersed servers located around the world. Each test measures the download data rate (i.e. from the server to the user computer) and the upload data rate (i.e. from the user's computer to the server). While there are many web services that provides free analysis of broadband Internet bandwidth which measures the speed and latency of an user's Internet connections, most of them require the use of Adobe Flash or Java Applets. Flash and Java applet based speed tests require external plug-ins to operate which are notably absent from most mobile operating systems like iOS and Android. Moreover, Flash and Java are further problematic for use in broadband Internet bandwidth testing for a variety of other reasons as well.

Accordingly, a continuing need exists for systems and methods of using an API for diagnosing, testing, troubleshooting, repairing, and maintaining broadband Internet connection.

### OBJECT OF THE INVENTION

Accordingly, it is an object of this invention to provide a method and system for testing and diagnosing broadband Internet bandwidth based on the use of an application programming interface (API).

It is an object of this invention to provide a method and system for the API for testing and diagnosing broadband Internet bandwidth written in HTML5 standard with JavaScript.

It is an object of this invention to provide a method and system for using the API for testing and diagnosing broadband Internet bandwidth without the use of Adobe Flash, Java Applets, or other third party plug-ins.

It is an object of this invention to provide a method and system for using the API for testing and diagnosing broadband Internet bandwidth that works on every device capable of running HTML5 browser.

It is an object of this invention to provide a method and system for using the API for testing and diagnosing broadband Internet bandwidth that works natively in browsers on devices running iOS, Android, and Windows without the need to download and install external applications.

It is an object of this invention to provide a method and system for using the API for testing and diagnosing broadband Internet bandwidth that works on mobile or hand-held devices without having to install any applications or “app”.

It is an object of this invention to provide a method and system for using the API for testing and diagnosing broadband Internet bandwidth to help determine whether the Internet Service Provider (ISP) maintains good peering relationships with other providers so their users sustain quality speeds throughout the internet, not just nearby.

It is an object of this invention to provide a method and system for using the API for testing and diagnosing broadband Internet bandwidth with a higher level of accuracy than other broadband Internet speed tests.

It is an object of this invention to provide a method and system for using the API for testing and diagnosing broadband Internet bandwidth that allows users to create their own speed test service with the use of the API.

It is an object of this invention to provide a method and system for using the API for testing and diagnosing broadband Internet bandwidth that allows user to benchmark the bandwidth of the users' website visitors.

It is an object of this invention to provide a method and system for using the API for testing and diagnosing broadband Internet bandwidth to help determine what audio and video streaming quality is suitable for the website.

It is an object of this invention to provide a method and system for using the API for testing and diagnosing broadband Internet bandwidth that determines and informed the user how long it will take to download or upload a specific file.

It is an object of this invention to provide a method and system for using the API for testing and diagnosing broadband Internet bandwidth that can be integrated in the users' Internet connected hardware or equipment.

It is an object of this invention to provide a method and system for using the API for testing and diagnosing broadband Internet bandwidth wherein the users can access a website or application which delegates the speed testing requirements to the speed test service using the speed test API.

It is an object of this invention to provide a method and system for using the API for testing and diagnosing broadband Internet bandwidth wherein the website does not host anything related to speed testing on its servers.

It is an object of this invention to provide a method and system for using the API for testing and diagnosing broadband Internet bandwidth wherein whenever the website needs to measure the user's speed, the website sends a request to the speed test API which connects to test servers.

It is an object of this invention to provide a method and system for using the API for testing and diagnosing broadband Internet bandwidth wherein the speed test API uses the speed test service behind the scene and returns the test results to a website which may or may not show any speed test or bandwidth information to the user.

It is an object of this invention to provide a method and system for using the API for testing and diagnosing broadband Internet bandwidth wherein a website uses the test results and may or may not notify the user about the test results.

It is an object of this invention to provide a method and system for using the API for testing and diagnosing broadband Internet bandwidth wherein a website uses the test results to determines the appropriate quality of the content that should be delivered to the user based on the user's Internet speed.

It is an object of this invention to provide a method and system for using the API for testing and diagnosing broadband Internet bandwidth wherein user does not know how the website measures its bandwidth speed, and the website also does not know how the speed test API measures the user's speed.

### SUMMARY OF THE INVENTION

In one aspect of the invention, a system for detecting and measuring broadband internet bandwidth is disclosed comprising: network; a host computer system wherein the host computer is connected to the network wherein the host computer comprises a platform wherein the platform comprises a speed test module; the platform further comprises an application programming interface; at least one user; at least one website is connected to the network wherein the website provides the user access to the speed test module whereby the website is connected to the speed test module via the application programming interface. In one embodiment, the speed test module embodies HTML5 language. In one embodiment, the speed test module embodies JavaScript. In one embodiment, the speed test module detects and measures broadband internet bandwidth by directly downloading and uploading sample files from the user's browser.

In one embodiment, the speed test module directly downloads sample file from small to large until a time for the download reaches a threshold. In one embodiment, the threshold is 8 seconds. In one embodiment, the speed test module measures the broadband internet bandwidth base on the sample file wherein the download time reaches the threshold.

In one embodiment, the sample file is selected from the group consist of 128 KB, 256 KB, 1 MB, 2 MB, 4 MB, 8 MB, 16 MB, 32 MB, 64 MB, and 128 MB. In one embodiment, the speed test module does not embody Adobe Flash language. In one embodiment, the speed test modules does not embody Java applets. In one embodiment, the website access the speed test module without the user's request.

In another aspect of the invention, a method to detect and to measure broadband internet bandwidth is disclosed comprising: providing a network; connecting a host computer system to the network wherein the host computer comprises a platform wherein the platform comprises a speed test module and an application programming interface;

having at least one user; connecting at least one website to the network wherein the website provides the user access to the speed test module whereby the website is connected to the speed test module via the application programming interface. In one embodiment, the speed test module embodies HTML5 language.

In one embodiment, the speed test module embodies JavaScript. In one embodiment, the speed test module detects and measures broadband internet bandwidth by directly downloading and uploading sample files from the user's browser. In one embodiment, the speed test module directly downloads sample file from small to large until a time for the download reaches a threshold. In one embodiment, the threshold is 8 seconds. In one embodiment, the speed test module measures the broadband internet bandwidth base on the sample file wherein the download time reaches the threshold. In one embodiment, the sample file is selected from the group consist of 128 KB, 256 KB, 1 MB, 2 MB, 4 MB, 8 MB, 16 MB, 32 MB, 64 MB, and 128 MB. In one embodiment, the speed test module does not embody Adobe Flash language. In one embodiment, the speed test modules does not embody Java applets. In one embodiment, the website access the speed test module without the user's request.

### BRIEF DESCRIPTION OF THE DRAWINGS

FIG. 1 is an architectural block diagram depicting an illustrative broadband network including representative broadband services, according to the present invention.

FIG. 2 is a schematic drawing illustrating a diagram of the Speed Test API as described by the invention disclosed herein.

FIG. 3 is a schematic drawing illustrating a diagram of the sustain time of the speed test to control the time and accuracy of the test.

### DETAILED DESCRIPTION OF THE INVENTION

The invention disclosed herein provides method and system for using an application programming interface (API) for detecting and measuring broadband internet bandwidth without the use of Java or Flash in diagnosing, testing, troubleshooting, repairing, and maintaining broadband Internet connection. More specifically, the method and system is an HTML5 internet speed test based on the use of an API, which specifies how some software components interact with each other. The invention is a pure HTML5 and JavaScript speed test that relied only on browser core technologies. Therefore, the API for testing and diagnosing broadband Internet is designed to work on any browser that supports HTML5 included desktop and mobile browsers.

The method and system tests an user's broadband Internet connection by directly downloading and uploading sample files from the user's browser. Therefore, it reflects the actual browsing and downloading experience. This is because when user's download webpages or media, the browser downloads large continuous files.

The download test begins with downloading the smallest sample size (128 KB), and it also watches the download duration. If it takes less than eight seconds, the next sample would be tried otherwise it continues with upload test. Among all downloaded samples only the last one which took more than eight seconds will be accepted and the user's download speed is actually based on the last sample file. When the download test completes, the upload test is initiated. The upload test will send back half of the last downloaded sample file to the server, and the upload speed will be calculated.

In order to ensure that the user's Internet connection is tested thoroughly, the method and system through the use of the API tests the user's bandwidth in several phases or passes. Sample file sizes increase gradually until it takes longer than eight seconds to download the sample file. As a result and unlike other speed tests, the invention disclosed herein is able to measure connection speeds in a wide range: from a slow 10 Kpbs Mobile GPRS to a blazing 100 Mbps (or higher) cable user automatically. The sample files are in these sizes: 128 KB, 256 KB, 1, 2, 4, 8, 16, 32, 64, and 128 MB.

To further advance the accuracy of the result of the speed test, the invention does not require any third party applications or plug-ins. Rather, the method and system tests the user's internet speed directly from the user's web browser without the use of any Adobe Flash or Java applets which requires much overhead.

Abode Flash is the wrong protocol to use for broadband Internet bandwidth testing because there is buffering between the application and the browser, and there is throughput bursting due to CPU usage. These variables must be taken into account in order to accurately calculate the true speed of the broadband Internet bandwidth. However, these variables are unknown because the each user's equipment and setup differs from one another. Therefore, Flash based tests need to make adjustments for these unknown variables through the use of rough estimates built into its calculations. As such, the results of these Flash based tests are often unreliable given the number of unknown variables involved. Flash can be buggy and crashes often, and, even more problematic is that it is not as widely supported. In fact, in early 2010, Apple announced that it will not support Flash in its products. Later, Microsoft also implied that it will discontinue Silverlight (a Flash-like plug-in) and it will not allow any browser plug-in, including Flash, in Internet Explorer 10.

The problem with Java Applets is that when the user first use it, the Java virtual machine (JVM) must be initialized and this can significantly slow down the process even on a relatively fast computer. Furthermore, the performance of a compiled Java program depends on how optimally its particular tasks are managed by the host Java Virtual Machine (JVM), and how well the JVM takes advantage of the features of the hardware and OS in doing so. Therefore, like the use of Adobe Flash, the use of Java Applets can significantly affect the results of a broadband Internet Bandwidth speed test.

Instead of replying on Adobe Flash or Java Applets, the API relies on the use of HTML5 and JavaScript. This allows the invention to eliminate unknown variables such as the buffering between application and the browser or the throughput bursting due to the CUP usage. It also significantly decreases the load time and increases the process of the speed test, without comprising the accuracy of the result. In fact, because the API does not rely on any plug-ins, but is completely based on browser core technologies, the result of the speed test resembles most closely with real world performance of the broadband Internet bandwidth. This also makes the method and systems more sensitive to browser configuration, and is, therefore, an excellent way to highlight performance differences between browsers.

The invention uses several test servers (PoPs) in various locations to make the test results more realist and to improve the result of the speed test. Other speed test services have a different approach about test server location. Some choose the nearest physical test server, probably inside the user's ISP. It seems illogical because the speed between the user and the selected server is always higher than the user's real speed for connecting to the rest of the Internet. Moreover, some speed test services use a single test server to test users' connection speed in all geographical locations. For example, imagine a user is in Asia or Australia while the test server is in the US. The result would be inaccurate again because the end user is very far away from the testing server.

The speed test API disclosed herein, on the other hand, use sample files hosted on a content delivery network or content distribution network (CDN). CDN is a large distributed system of servers deployed in multiple data centers across the Internet, and its goal is to serve content to end-users with high availability and high performance. The speed test benefits from 41 or more super servers known as PoP or point of presence. A PoP is an artificial demacration point or interface point between communicating entities. Each PoP may use several servers, and they are located in various places around the world near primary internet exchange points. These super servers have a massive computing and caching power, and are directly connected to all major backbone networks.

When the speed test is initiated, the quickest and most reliable server, not necessarily the nearest, would be chosen. There are many factors involved in selecting the best test server for the user. However, this is done automatically using CDN technology to ensure the best testing quality. Specifically, the speed test PoP locations currently are as follows:
North America: Ashburn(2), Atlanta, Chicago(2), Dallas(2), Los Angeles(3), Miami(2), New York(2), San Jose and Seattle
Europe: Amsterdam, Frankfurt(2), London, Madrid, Paris(2), Vienna, Copenhagen, Stockholm(2), Helsinki, Milan and Warsaw
Asia: Hong Kong, Singapore, Batam, Osaka, Tokyo(2), Jakarta and Kaohsiung
Australia: Sydney, Melbourne
South America: Sao Paulo

The method and system of the invention disclosed herein tests and diagnoses broadband Internet bandwidth based on the use of an application programming interface (API). This allows the method and system to be easily accessed. The user can access a website or application which delegates the speed testing requirements to the speed test service using the speed test API. The website does not host anything related to speed testing on its servers. Whenever the website needs to measure the user's speed, the website sends a request to the speed test API which connects to test servers. The speed test API uses the speed test service behind the scene and returns the test results to the website. The website uses the test results, and may or may not notify the user about the test results. The user does not know how the website measures its bandwidth speed, and the website also does not know how the speed test API measures the user's speed.

For example, a website that requires a high speed, broadband Internet such as one that provides audio- or video-streaming may find much use in the speed test API disclosed herein. Specifically, because each individual user has different computer configuration and Internet connection, the website would do well to tailor the quality of the contents to improve user-experiences. This is because while some people may have access to high speed broadband Internet, others may only have access to slower speed Internet. In which case, it would not make sense to make delivery low quality or standard definition quality stream to both groups of users since one group of users can handle high definition streams. On the other hand, to stream only high definition or Full HD content to both groups would greatly hinder if not completely destroy the user experiences of the group with slower Internet as they cannot load the contents in a reasonable time. Therefore, websites must tailor its contents as well as its delivery system to all of its individual users to ensure ifs user friendly. To this end, a website is able to tailor its contents and delivery system through the speed test API.

In particular, when the website is determining the best audio or video quality, it does a sped test in the background using the speed test API. Based on the results, the website selects the audio or video quality that should be delivered (i.e. low quality, standard definition, high definition, or Full HD). In such a case, the website would not need to show any speed test or bandwidth related information to the user. The speed test API would simply run in the background to help tailor the website user experience to the individual user.

In order to use the speed test API disclosed by the invention in a website, the user needs to include the JavaScript library in the webpage tag. After the api.js is completely loaded, the user can configure and use SomApi object in the JavaScrip source code. All initial settings must be done before starting a test. Below is a brief description of the API.

### SomApi Object

SomApi.account
This is the user's account number (or API Key). The user can get it from http://speedof.me/api/user ifgoo the user doesn't have one already. Account number looks like this: “SOM123456543210”.

SomApi.domainName
It's the user's website domain or sub-domain. It should be something like this: “speedtest.example.com”.
Please keep in mind that the ‘Domain’ in the User Settings, ‘domainName’ in the JavaScript code and the actual website domain that the user is testing on must all match.

SomApi.config
This object is used to configure the speed test and the way it behaves. Here the user can see this object with its default property values:

```
SomApi.config = {
        sustainTime: 4,
        testServerEnabled: true,
        userInfoEnabled: true,
        latencyTestEnabled: true,
        uploadTestEnabled: true,
        progress: {
            enabled: true,
            verbose: false
        }
}
```

SomApi.config.sustainTime
The SpeedOf.Me website sustains the download for 8 seconds for the sake of accuracy (read more here: http://speedof.me/howitworks.html). The user can adjust this time to best suit his needs. The user may choose from 1 to 8 seconds. (Default value is 4 seconds). The higher this number, the more accurate and time consuming the test would be.
The user also need to add some time for the upload test. Since the upload sample file size is determined based on the last downloaded sample, sustainTime can indirectly affect the upload test sample file size and the entire speed test time.

SomApi.config.testServerEnabled
Determines whether to find the test server name or not. If the user doesn't care about what test server has been used for the test, he may disable this feature by setting its value to false. The default value is true.

SomApi.config.userInfoEnabled
Determines whether to find the user information such as IP address and hostname or not. If the user doesn't need this kind of information, he may disable this feature by setting its value to false. The default value is true.

SomApi.config.latencyTestEnabled
Determines whether to perform latency (ping) and jitter test or not. If the user doesn't want to do this test, he may disable this feature by setting its value to false. The default value is true.

SomApi.config.uploadTestEnabled
Determines whether to perform upload test or not. If the user wants to measure download speed only, he may disable this feature by setting its value to false. The default value is true.

SomApi.config.progress
This is an object itself and is used to configure the progress event feature:

```
SomApi.config.progress = {
      enabled: true,
      verbose: false
}
```

SomApi.config.progress.enabled
   Determines whether to send progress events or not. By enabling it, onProgress event will be activated. If the user doesn't want to show real-time progress to the user, he may disable this feature by setting its value to false. If enabled, SomApi.onProgress callback will be called whenever there is a progress in the test. The default value is true.
SomApi.config.progress.verbose
   This only works if SomApi.config.progress.enabled is true. If enabled, it includes and sends real-time current speed in the progress event. This is useful when the user wants to show and visualize whatever is happening behind the scene (like what SpeedOf.Me public website does). See SomApi.onProgress for more information. The default value is false.

SomApi.startTest
Call this function to start the test. All test configuration and settings must be done before calling this function.

SomApi.onTestCompleted
When the test is completed, the callback to this method will be called and the user will be notified that the test is over and the test result is ready. Test result will be passed as an event args to the callback function. The testResult object has the following properties:

```
testResult = {
      download,
      upload,
      latency,
      jitter,
      testServer,
      ip_address,
      hostname
}
```

testResult.download: Download speed in Mbps.
testResult.upload: Upload speed in Mbps. It will be empty string if SomApi.config.uploadTestEnabled is false.
testResult.latency: Latency (ping) in milliseconds. It will be empty string if SomApi.config.latencyTestEnabled is false.
testResult.jitter: Jitter in milliseconds. It will be empty string if SomApi.config.latencyTestEnabled is false.
testResult.testServer: Test server name. It will be empty string if SomApi.config.testServerEnabled is false.
testResult.ip_address: User IP Address. It will be empty string if SomApi.config.userInfoEnabled is false.
testResult.hostname: User ISP host name. It will be empty string if SomApi.config.userInfoEnabled is false.
The user can always access a copy of the test result directly by reading SomApi.testResult

SomApi.onProgress
If SomApi.config.progress.enabled is true, the callback to this method will be called whenever there is a progress in the test. It receives a progressObject as its argument which includes the following properties:

```
progressObject = {
      type,
        pass,
      percentDone,
      currentSpeed
}
```

progressObject.type: Progress type can be “latency”, “download” or “upload”. It helps the user knows what to expect from other progressObject properties.
progressObject.pass: It is the current test pass. It is only meaningful for progress types of “download” or “upload” and shows the current pass of the test process. For download test it can be 1 to 11 and for upload test it is always 1. (With current algorithm. It may change in future) and for latency test it is always an empty string.
progressObject.percentDone: It is the percentage of competition for the latency test or the current test pass in download/upload tests. It's a number between 0 and 100. It does not show the percentage of the entire test.
   For instance, if the download test occurs in five passes and the upload test in one pass, percentDone will be counted from 0 to 100 six times.
progressObject.currentSpeed: It is the real-time current speed in download/upload test. It will be empty string if SomApi.config.progress.verbose is false or if the progress type is “latency”.
   SomApi.onError

The user may specify a callback to this method. If something goes wrong, the error details will be passed to the callback function. The user may or may not show the error details to the users. The error object has the following properties:

```
error = {
        code,
        message
}
```

Two sample codes (regular and advanced) are provided below:

### Sample Code

```
<html>
<head>
      <script src=“http://speedof.me/api/api.js” type=“text/javascript”>
      </script>
</head>
<body>
<h2>SpeedOf.Me API Consumer - Sample Page</h2>
<button id=“btnStart” type=“button” onclick=“btnStartClick( )”>Start
Test</button>
<div id=“msg”></div>
<script type=“text/javascript”>
      SomApi.account = “SOM524dca9d0aae6”; //user API Key here
      SomApi.domainName = “speedof.me”; //user domain or
      sub-domain here
      SomApi.config.sustainTime = 4;
      SomApi.onTestCompleted = onTestCompleted;
      SomApi.onError = onError;
      var msgDiv = document.getElementById(“msg”);
      function btnStartClick( ) {
          msgDiv.innerHTML = “<h3>Speed test in progress. Please
          wait...</h3>”;
          SomApi.startTest( );
      }
      function onTestCompleted(testResult) {
          msgDiv.innerHTML =
          “<h3>”+
                “Download: ” +testResult.download +“Mbps <br/>”+
                “Upload: ” +testResult.upload +“Mbps <br/>”+
                “Latency: ” +testResult.latency +“ms <br/>”+
                “Jitter: ” +testResult.jitter +“ms <br/>”+
                “Test Server: ”+testResult.testServer +“<br/>”+
                “IP: ” +testResult.ip_address +“<br/>”+
                “Hostnames ” +testResult.hostname +“<br/>”+
          “</h3>”;
      }
      function onError(error) {
          msgDiv.innerHTML = “Error ”+ error.code + “: ”+error.
          message;
      }
</script>
</body>
</html>
```

### Sample Code (Advance)

```
<!DOCTYPE html>
<html>
<head>
  <title>SpeedOf.Me API Consumer - Advanced Sample Page</title>
  <meta name=“viewport” content=“user-scalable=no, width=device-width, maximum-
scale=1.0”>
  <meta http-equiv=“X-UA-Compatible” content=“IE=edge” />
  <script src=“http://speedof.me/api/api.js” type=“text/javascript”></script>
</head>
<body>
  <h2>SpeedOf.Me API Consumer - Advanced Sample Page</h2>
  <div style=“float:left; margin-right:30px”>
    <h3>--------------- Settings ---------------</h3><form>
      Faster Test<input type=“range” id=“sustainTime” min=“1” max=“8” value=“4”> More
Accurate Test<br /><br />
      <input type=“checkbox” id=“testServerEnabled” checked=“checked”>Find Test
Server<br />
      <input type=“checkbox” id=“userInfoEnabled” checked=“checked”>Find User Info<br />
      <input type=“checkbox” id=“latencyTestEnabled” checked=“checked”>Do Latency
Test<br />
      <input type=“checkbox” id=“uploadTestEnabled” checked=“checked”>Do Upload
Test<br />
      <input type=“checkbox” id=“progress.enabled” checked=“checked”>Show Progress<br
/>
      <input type=“checkbox” id=“progress.verbose” checked=“checked”>Verbose
Progress<br />
    </form>
  </div>
  <div id=“prgs” style=“float:left; margin-right:30px”></div>
  <div id=“msg” style=“float:left;”></div>
  <div style=“clear:both;”><br /><button style=“width:150px” id=“btnStart” type=“button”
onclick=“btnStartClick( )”>Start Test</button><br /></div>
  <div style=“clear:both;”><br />For more information and getting an API key please visit <a
href=“http://speedof.me/api” target=“_blank”>speedof.me/api</a></div>
  <script type=“text/javascript”>
    SomApi.account = “SOM524dca9d0aae6”; //user API Key here
    SomApi.domainName = “speedof.me”; //user domain or sub-domain here
    SomApi.onTestCompleted = onTestCompleted;
    SomApi.onError = onError;
    SomApi.onProgress = onProgress;
    var msgDiv = document.getElementById(“msg”);
    var prgsDiv = document.getElementById(“prgs”);
    function btnStartClick( ) {
      //set config values
                SomApi.config.sustainTime =
document.getElementById(“sustainTime”).value;
      SomApi.config.testServerEnabled =
document.getElementById(“testServerEnabled”).checked;
      SomApi.config.userInfoEnabled =
document.getElementById(“userInfoEnabled”).checked;
      SomApi.config.latencyTestEnabled =
document.getElementById(“latencyTestEnabled”).checked;
      SomApi.config.uploadTestEnabled =
document.getElementById(“uploadTestEnabled”).checked;
      SomApi.config.progress.enabled =
document.getElementById(“progress.enabled”).checked;
      SomApi.config.progress.verbose =
document.getElementById(“progress.verbose”).checked;
      msgDiv.innerHTML = “<h3>--------------- Test Result ---------------</h3><h4>” +
        “Speed test in progress. Please wait...</h4>”;
      SomApi.startTest( );
    }
    function onTestCompleted(testResult) {
      msgDiv.innerHTML = “<h3>--------------- Test Result ---------------</h3><h4>” +
        “Download: ” + testResult.download + “ Mbps <br/>” +
        “Upload: ” + testResult.upload + “ Mbps <br/>” +
        “Latency: ” + testResult.latency + “ ms <br/>” +
        “Jitter: ” + testResult.jitter + “ ms <br/>” +
        “Test Server: ” + testResult.testServer + “<br/>” +
        “IP: ” + testResult.ip_address + “<br/>” +
        “Hostname: ” + testResult.hostname + “<br/>” +
      “</h4>”;
    }
    function onError(error) {
      msgDiv.innerHTML = “Error ” + error.code + “: ” + error.message;
    }
    function onProgress(progress) {
      prgsDiv.innerHTML =
      “<h3>--------------- Progress ---------------</h3><h4>” +
        “Progress Type: ” + progress.type + “<br/>” +
        “Pass: ” + progress.pass + “<br/>” +
        “Percent Done: ” + progress.percentDone + “% <br/>” +
        “Current Speed: ” + progress.currentSpeed + “ Mbps <br/>” +
      “<h4>”;
    }
  </script>
</body>
</html>
```

### DETAILED DESCRIPTION OF THE DRAWINGS

These and other features and advantages of the invention will now be described with reference to the drawings of certain preferred embodiments, which are intended to illustrate and not to limit the invention, and in which:

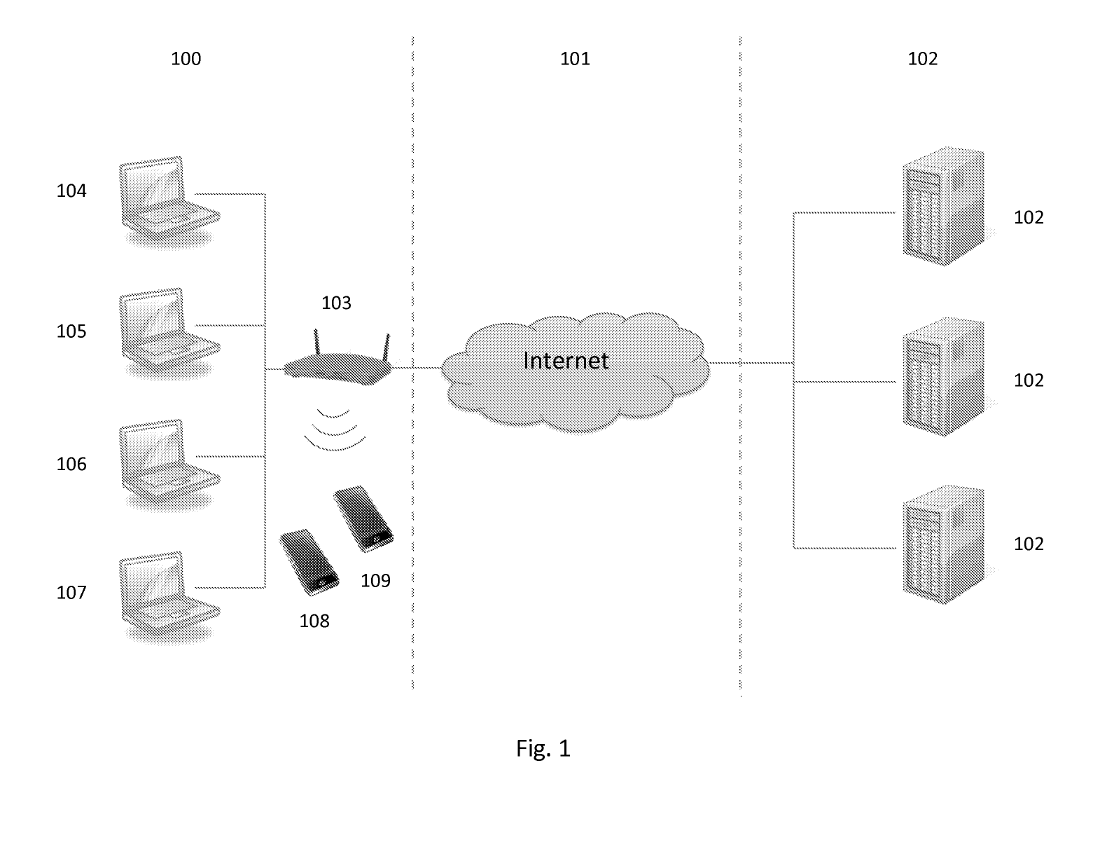

Referring to FIG. 1, there is shown an architectural block diagram that depicts a broadband network including representative broadband services. Specifically, shown therein is a broadband network that is further divided into three broad sections namely, a home network 100, an access network 101, and a service provider network 102. As shown, the home network 100 is interconnected to access network 101 through access device 103. The access device 103 between the home network 100 and the access network 101 may be a cable modem with wireless router built-in using cable television facilities as access facility. Alternatively, access device 103 may be a DSL modem with wireless router built-in operating via existing copper media as access facility. It is useful to note that the invention is not limited to these two, commonly available access options, and it is expected that a number of technologies are either available or emerging that hold promise for broadband access and therefore use without invention. The home network environment 100 may include one or more personal computers 104, 105, 106, 107 or mobile devices 108, 109 that are connected to a gateway via wired (i.e. Ethernet, USB, UTP, etc.) or wireless (i.e. 802.11x technologies).

The home network connects to the access network 101 that is further connected to the service provider network 102. The service provider network 102 is comprised of an array of servers 110, 111, 112.

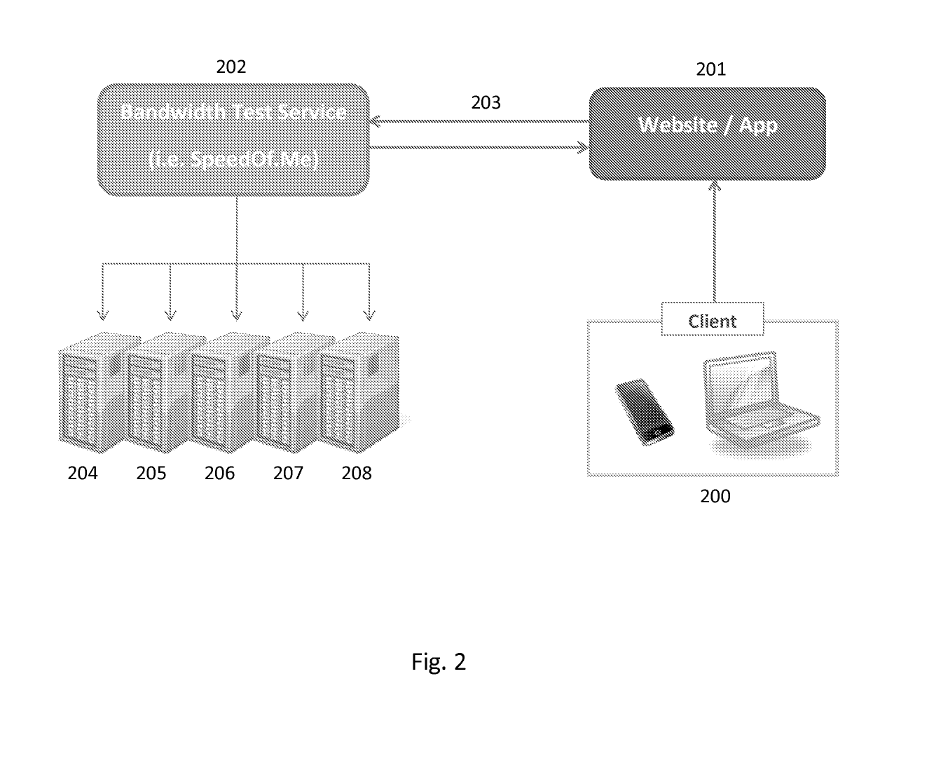

Referring to FIG. 2, the schematic drawing illustrates a diagram of the Speed Test API as described by the invention disclosed herein. The user (or client) 200 access the Website 201 for the speed test 202. The Website (or App) 201 delegates the speed testing requirements to the Speed Test Service 202 using the Speed Test API 203. The Website 201 doesn't host anything related to speed testing on its server(s). The Speed Test Service 202 relies on its own servers 204, 205, 206, 207, 208. Whenever the Website 201 needs to measure the user's speed, it just asks the Speed Test API 203. The Speed Test API 203, uses the Speed Test Service behind the scene and returns the test result to the Website 201. The Website 201 uses (consumes) the test results. It may or may not notify the user 200 about the test results. The user 200 never knows how the Website 201 measures its bandwidth speed. Also, the Website 200 never knows and cares how the Speed Test API 203 measures the user's speed.

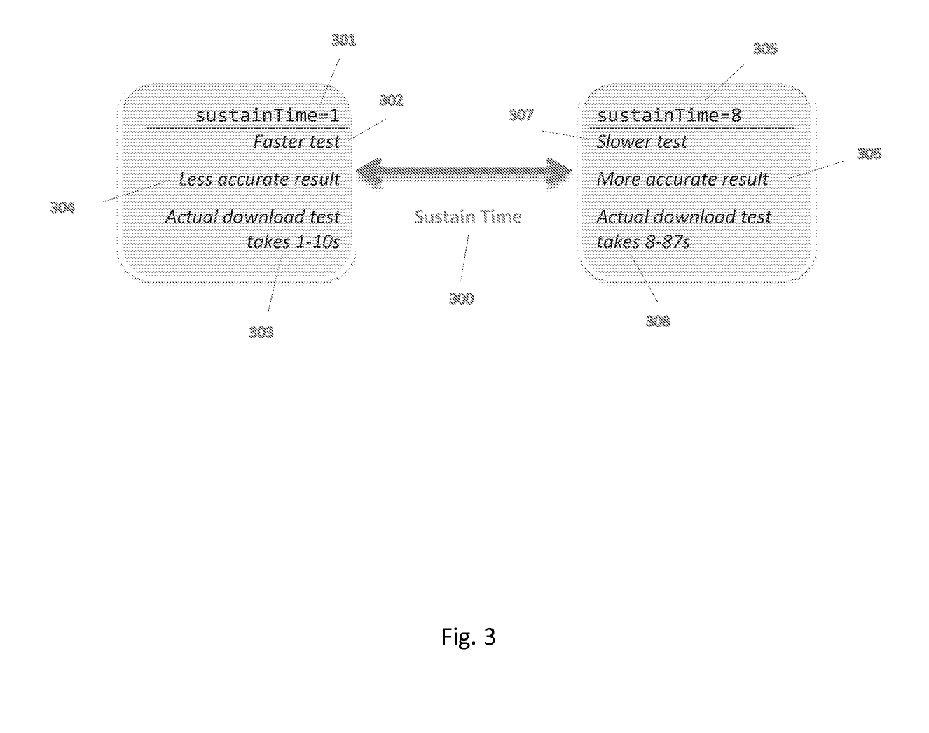

Referring to FIG. 3, the user can adjust the time to best suit his needs. The user may choose from 1 to 8 seconds of sustain time 300 for the sake of accuracy, where the default time is 4 seconds. The high the number, the more accurate and time consuming the test is. For example, with a sustain time of 1 second 301, it is the fastest test 302 where the actual download test would take about 1 to 10 seconds 303. The result, however, would be the less accurate 304 than a test with a higher sustain time. On the other hand, with a sustain time of 8 seconds 305, it would yield a more accurate result 306. However, it would be a slower test 307 than a test with a lower sustain time, and the actual download test would take 8 to 87 seconds 308.

It should also be noted that some time will be added for the upload test. Since the upload sample file size is determined based on the last download sample, the sustain time can also indirectly affect the upload test sample file size and the entire speed test time. In other words, if the sustain time is higher, the download file size is also higher; in turn, the upload sample file size is based on the download file size, therefore, the upload time will also be longer.

1. A system for detecting and measuring broadband internet bandwidth comprising:
a. network;
b. a host computer system wherein said host computer is connected to said network wherein said host computer comprises a platform wherein said platform comprises a speed test module;
c. said platform further comprises an application programming interface;
d. at least one user;
e. at least one website is connected to said network wherein said website provides said user access to said speed test module whereby said website is connected to said speed test module via said application programming interface.

2. The system of claim 1 wherein said speed test module embodies HTML5 language.

3. The system of claim 1 wherein said speed test module embodies JavaScript.

4. The system of claim 1 wherein said speed test module detects and measures broadband internet bandwidth by directly downloading and uploading sample files from said user's browser.

5. The system of claim 4 wherein said speed test module directly downloads sample file from small to large until a time for said download reaches a threshold.

6. The system of claim 5 wherein said threshold is 8 seconds.

7. The system of claim 5 wherein said speed test module measures the broadband internet bandwidth base on said sample file wherein said download time reaches said threshold.

8. The system of claim 5 wherein said sample file is selected from the group consist of 128 KB, 256 KB, 1 MB, 2 MB, 4 MB, 8 MB, 16 MB, 32 MB, 64 MB, and 128 MB.

9. The system of claim 1 wherein said speed test module does not embody Adobe Flash language.

10. The system of claim 1 wherein said speed test modules does not embody Java applets.

11. The system of claim 1 wherein said website access said speed test module without said user's request.

12. A method to detect and to measure broadband internet bandwidth comprising:
a. providing a network;
b. connecting a host computer system to said network wherein said host computer comprises a platform wherein said platform comprises a speed test module and an application programming interface;
d. having at least one user;
e. connecting at least one website to said network wherein said website provides said user access to said speed test module whereby said website is connected to said speed test module via said application programming interface.

13. The method of claim 12 wherein said speed test module embodies HTML5 language.

14. The method of claim 12 wherein said speed test module embodies JavaScript.

15. The method of claim 12 wherein said speed test module detects and measures broadband internet bandwidth by directly downloading and uploading sample files from said user's browser.

16. The method of claim 12 wherein said speed test module directly downloads sample file from small to large until a time for said download reaches a threshold.

17. The method of claim 12 wherein said threshold is 8 seconds.

18. The method of claim 12 wherein said speed test module measures the broadband internet bandwidth base on said sample file wherein said download time reaches said threshold.

19. The method of claim 16 wherein said sample file is selected from the group consist of 128 KB, 256 KB, 1 MB, 2 MB, 4 MB, 8 MB, 16 MB, 32 MB, 64 MB, and 128 MB.

20. The method of claim 12 wherein said speed test module does not embody Adobe Flash language.

21. The method of claim 12 wherein said speed test modules does not embody Java applets.

22. The method of claim 12 wherein said website access said speed test module without said user's request.
